(19) United States
(12) Patent Application Publication
(10) Pub. No.: US 2009/0295293 A1
(43) Pub. Date: Dec. 3, 2009

(54) FLUID DRIVEN ROTOR WITH LIGHTS

(76) Inventors: Tom Lawton, Malmesbury Wiltshire (GB); Milan Vasilko, Bournemouth Dorset (GB)

Correspondence Address: Workman Nydegger;1000 Eagle Gate Tower, 60 East South Temple, Salt Lake City, UT, 84111, US

(21) Appl. No.: 12/295,076

(22) PCT Filed: Mar. 29, 2007
(86) PCT No.: PCT/GB2007/050168

§ 371 Date: May 7, 2009

(30) Foreign Application Priority Data
Apr. 1, 2006 (GB) 0606652.6

(51) Int. Cl. F21S 9/04; F03D 9/00

(52) U.S. Cl. 315/76; 290/55

(57) ABSTRACT

A light comprises at least one electrically powered light source and provided on at least one rotatable blade twisted around a central elongate section so as to form at least one partial or full helix shaped section. A generator is coupled to the blade such that upon rotation of the blade, electricity is generated which powers the light source.

This invention relates to a light. More particularly but not exclusively this invention relates to a decorative lighting device which is either wind, solar or water powered.

Outdoor decorative lighting devices are known, however, most require either mains or battery power which can be inconvenient in an outdoor environment. Also the use of electricity to power such lights can be expensive.

Portable wind powered lights are known and one such product is disclosed in U.S. Pat. No. 6,624,530. This patent discloses the use of a wind operated propeller coupled to a generator which then provides an electrically powered light source. One problem associated with this prior invention is that the propeller blades are operable only when the wind blows in a convenient direction. Thus the wind turbine may not be operable for a certain amount of time. Also such wind turbines with horizontal axes need to be located in a reasonably high position so as to attract higher wind speeds and also because the turbine blades could present danger to persons if located nearer to the ground.

It is an object of the present invention to provide a wind or water powered light source which attempts to alleviate the aforementioned problems.

According to the present invention there is provided a light comprising at least one electrically powered light source and at least one rotatable blade twisted around a central elongate section so as to form at least one partial or full helix shaped section such that upon rotation of the blade the light source is rotated. Advantageously rotation of the blade provides an aesthetically pleasing light which rotates so as to provide light in differing directions. The device is safe to use in close proximity to people and further advantageously the twisted blade provides for a smooth rotation.

Preferably the elongate central section is operably coupled to a generator wherein upon rotation of the blade an electrical current is provided by the generator to power the light source.

Advantageously the rotation of the blade assembly provides rotational movement of the shaft which enables electrical energy to be produced by a generator which in turn powers the light source. The helix shaped arrangement of the blade assembly enables the unit to be wind or wave powered. Also the ‘soft’ curvature of the helical shape of the blade does not present as much of a danger to persons located nearby as standard non helix shaped blade assembly.

Preferably the light source is mounted on the blade assembly.

The blade assembly may preferably comprise a plurality of individual blades mounted adjacent each other in a vertical plane so as to together form a helix blade assembly.

The generator is preferably wind powered.

The generator preferably comprises an electromagnetic field to convert the rotational energy of the blade assembly into electrical energy.

The generator preferably comprises a plurality of copper coils, an array of magnets, and a stator rod positioned adjacent one another so as to form a cylindrical array of copper coils, said cylindrical copper coil array being coupled to said shaft such that upon shaft rotation the cylindrical array of copper coils rotates.

Preferably the shaft is hollow. Preferably the blade assembly is rotatable about a vertical axis and is attached at its top end to a stationary cap and at its lower end to a stationary base unit. Preferably the blade assembly and associated shaft is attached to the base unit and cap via bearings which allow its free rotation about its vertical axis under wind or wave power.

Preferably the light also comprises a plurality of light emitting diodes which are provided on the blade assembly. Preferably the light emitting diodes provided with electrical energy from the generator such that the light emitting diodes are lit upon rotation of the blade assembly.

Alternatively the light may comprise electroluminescent wires as a light source.

Preferably the stator rod is attached to the cap and base unit and is positioned within the hollow shaft such that the stator rod lies substantially in the plane of rotational axis of the blade assembly.

Preferably each individual rotor blade comprises a semi-frustroconical shape. Preferably the substantially flat top portion of the semi-frustroconical shaped rotor blades act as an internal rib within the double helix shape blade assembly so as to advantageously discourage vertical airflow.

Preferably the blade edges define a double helix shape. Advantageously this double helix provides smooth rotation of the blade under wind power and also provides an aesthetically pleasing light source.

An embodiment of the present invention will now be described with reference to the accompanying drawings in which:

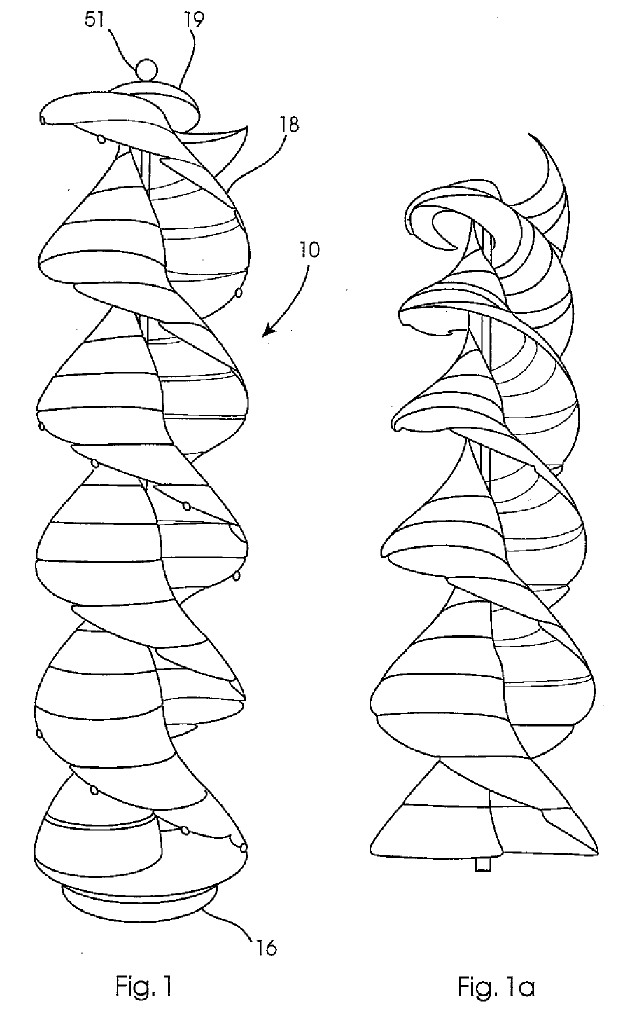

FIG. 1 is a front view of a light device according to an embodiment of the present invention.

FIG. 1a is a front view from below of the light device of FIG. 1 showing the inner blade surfaces more clearly.

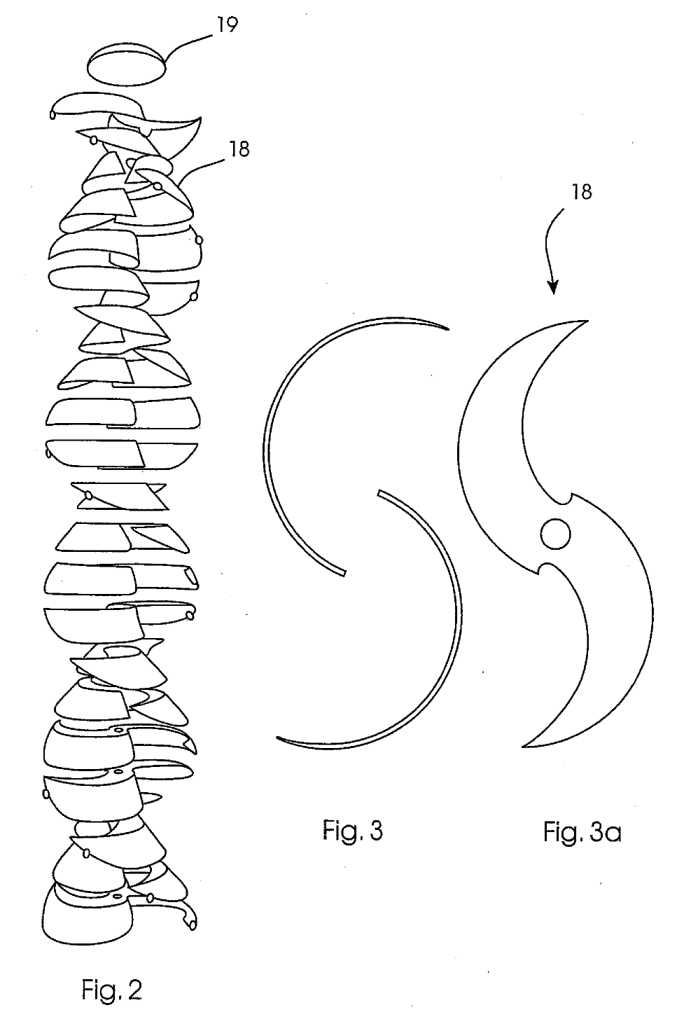

FIG. 2 is an expanded view of the light device of FIG. 1.

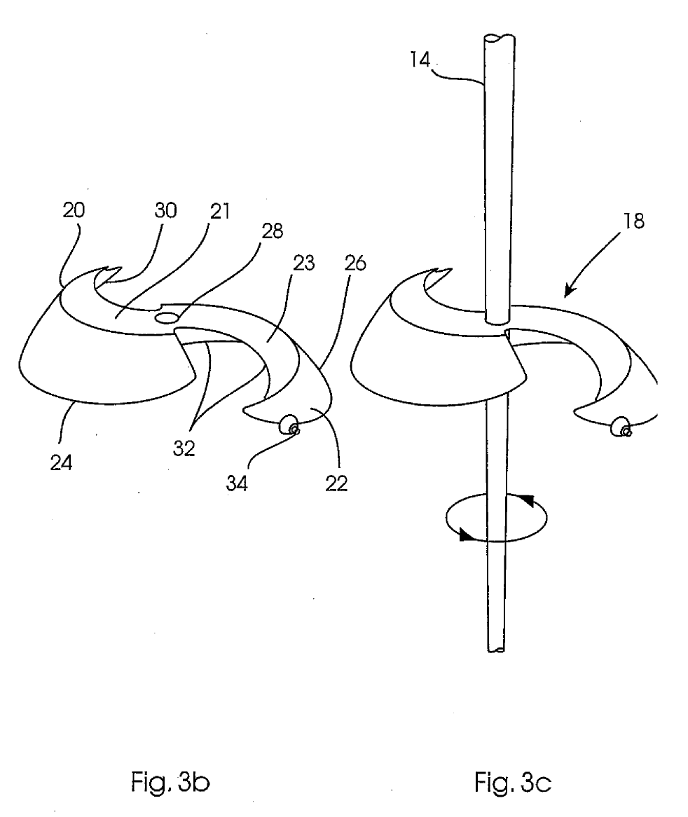

FIG. 3 is a cross-section of a single blade element

FIG. 3a is a top view of a blade element of FIG. 2.

FIG. 3b is a perspective view of the single blade element and internal rib of FIG. 2.

FIG. 3c is a perspective view showing the mounting of a single blade element and internal rib on a rotating mounting rod.

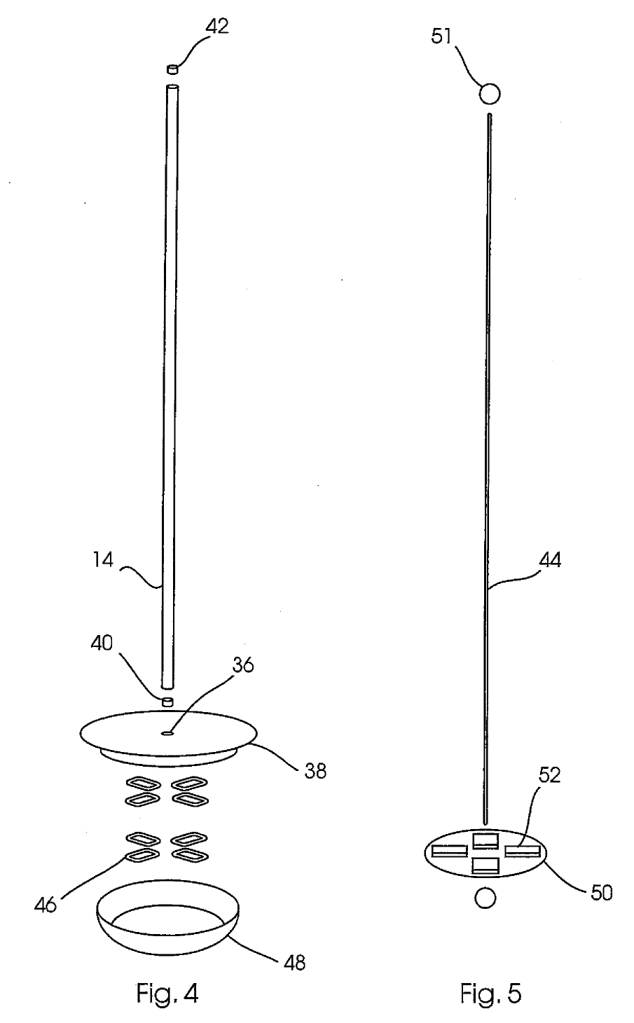

FIG. 4 is an expanded view of the rotating core assembly of lighting device of FIG. 1 with the blades removed.

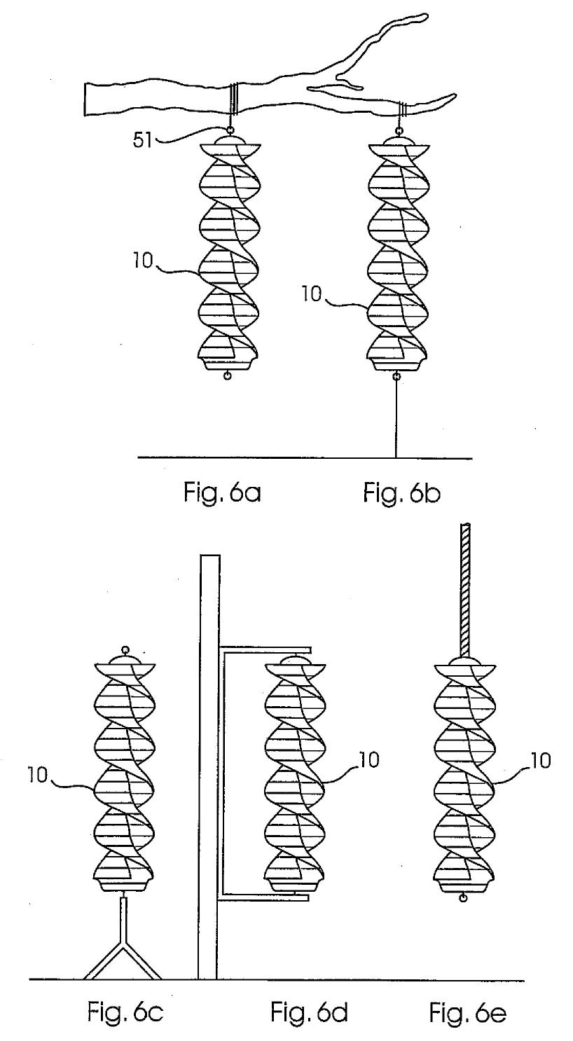

FIG. 5 is an expanded view of the stationary central core assembly of FIG. 1.

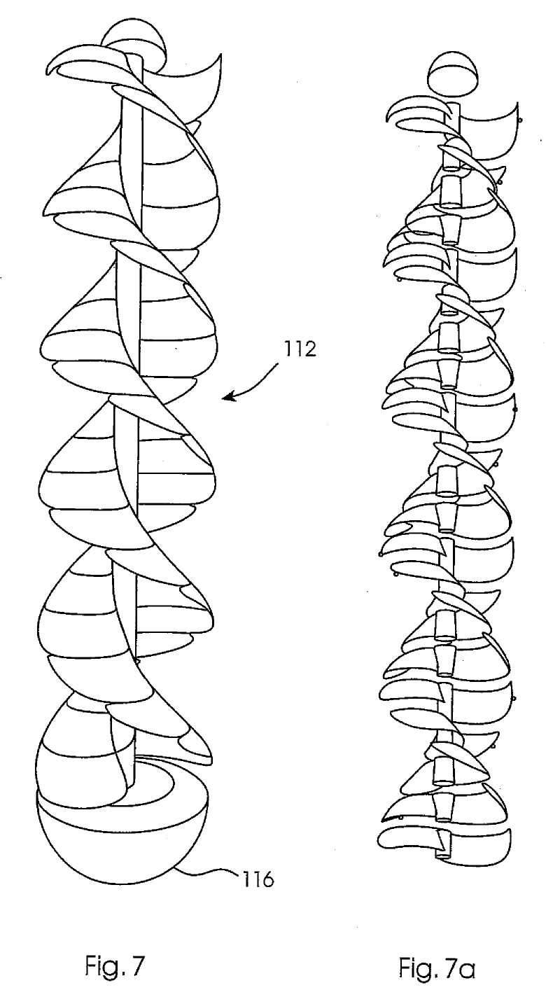

FIGS. 6a to 6e show different mounting arrangements of the light device of FIG. 1.

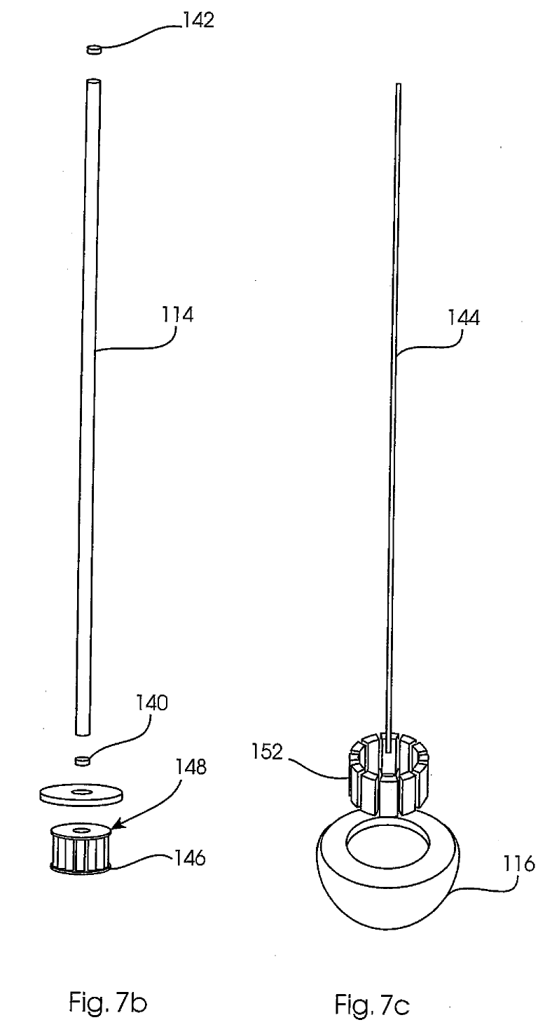

FIG. 7 is a front view of a lighting device according to a second embodiment of the present invention.

FIG. 7a is an expanded view of the blades of FIG. 7.

FIG. 7b is an expanded view of the rotating internal elements of FIG. 7.

FIG. 7c is an expanded view of the stationary internal elements of FIG. 7.

Referring to FIG. 1 a light emitting device 10 comprises a helix shaped set of blades 18 attached to a hollow tube 14. The tube is itself rotatably mounted within a base unit 16.

The set of blades 18 comprise a series of individual blade pairs. The blade pairs are mounted on a hollow tube 14 and are mounted in positions above each other in the vertical plane such that a twisted blade assembly is formed by their aerofoil sections. Each blade pair 18 comprises two wing sections 20 and 22 each comprising an aerofoil section. This is shown clearly in FIG. 3

Each wing segment 20 and 22 comprises a frustroconical shaped outer surface 24 and the blade segment 22 comprises a frustroconical shaped outer surface 26.

Each wing segment 20 and 22 also comprises a substantially flat top section 21 and 23. When the blades are in situ on the hollow tube 14 these top surfaces 21 and 23 act as “ribs” on the internal surface of the double helix shaped set of blades 18. These “ribs” can be seen more clearly by reference to FIG. 1 and FIG. 1a. Advantageously these “ribs” help to discourage vertical air flow.

Each pair of blades 18 could be described as a wing module and a circular aperture 28 is provided at the centre of the wing module span breadth which is provided which is suitable for mounting on the hollow tube 14.

Each blade segment 20 and 22 comprises a 3D shape each having an aerofoil section 30 and 32. A plurality of light emitting diodes are mounted at the tip of each blade segment 26 and connect to the electronic circuitry mounted within each blade segment.

Now referring to FIGS. 4 and 5, the hollow tube 14 is shown more clearly without the blade parts 18. The tube 14 comprises a single hollow tube vertically mounted in a base housing 38. The base housing comprises a plastic cylinder having a central aperture 36 shaped to receive the tube 14.

A pair of bearings 40 and 42 is mounted within the hollow tube ends. The base housing 38 comprises an aperture 36 so as to allow the tube to be mounted therein.

A stator rod 44 is mounted within the tube 14 through the aperture 36 and is itself immovably attached to the cap 19. A copper coil 46 is provided within a base cap 48 again as shown in the expanded view of FIG. 4. The stator 44 is itself connected to a flat plate 50 of magnets 52. The copper coil is connected to the rotating tube 14 and thus the copper wire coil rotates upon rotation of the hollow tube 14.

Thus in use an electrical current is produced when the blade pairs rotate under wind or water power and rotate the tube 14. The electronic currents produced in the generator are rectified and filtered into a low-ripple DC current suitable for powering a collection of light emitting diodes 34.

In use, the helix shaped set of blades 18 rotate in one direction around its vertical axes. When the axes of this blade set 18 are at right angles to the wind direction and when it is located in the direction of the wind it creates a pleasing aesthetic result of a continuous upward turning spiral. This is particularly effective when the LED's are lit. Thus, advantageously, the rotation of the set of blades 18 rotates the tube 14 which in turn also rotates the copper coil 46 housed within the base section 38. This rotation of the copper coil 46 within the magnetic field produced by the array of magnets 52 provides an electric current which subsequently powers the LED's 34 and thus produces wind powered light. It is also envisaged that the blades could be powered by water but the effect would be the same.

Also advantageously, there is no electrical or mechanical contact between the rotating blade unit 18 and the stator of the electrical generator unit other than the bearings 42 and 40. Thus the construction is a wear resistant one and maximises the product's useful lifetime.

Further, the amount of electrical energy generated increases correspondingly with the increasing speed of blade unit 14 rotation. This increases the light intensity produced by LEDs 34 correspondingly with the increasing speed of wind and therefore provides an aesthetically pleasing light source. Referring to FIGS. 6a to 6e various mounting arrangements for the light device are shown. FIGS. 6a and 6b show the light 10 attached to a tree branch. FIGS. 6c and 6d show the light attached to stands. FIG. 6e shows the light hung from a rope.

Now referring to FIG. 7, a further embodiment of the present invention is shown in FIGS. 7, 7a, 7b and 7c. The construction of this embodiment of the invention is similar to that previously described except that the set of blades 112 do not comprise the internal ribs 21 and 23 of the embodiment shown in FIGS. 3a, 3b and 3c. Also in this embodiment of the present invention the base unit 116 is stationary and comprises a cylindrical array of magnets 152 securely located within the semi spherical hollow base section 116. The cores of copper wire 146 are formed into a hollow cylinder 148 and rotatably mounted within the base 116 and the magnet array 152. The hollow tube 114 is securely connected to the copper coil unit 148 such that upon rotation of the tube 114 the copper coil unit 148 rotates within the magnetic field produced by the array of magnets 152 and thus provides an electric current. As previously described this electronic current provides electrical energy to the LED's through the electronic circuitry mounted within the set of blades 112.

Further alternative embodiments of the present invention are envisaged. For example, the blade unit 18 could be rotated manually via a cord suspended from the base of the unit which in turn is attached to a spring loaded “spragg-type” clutch mechanism fitted to a vertically aligned spiral rod. Thus when the cord is manually pulled downwards the linear motion is converted into rotary motion causing the blade to spin in one direction. Once the cord is released the spring returns the mechanism to its original position and the clutch is reset for the cord to be pulled again. The clutch would enable the blade unit 18 to rotate and therefore light the LED's. This would enable the light device to be operable without the need for wind or wave power.

It is also envisaged that the light could be rotated and powered by flow of air produced while the light is attached to a moving object, such a vehicle or a toy. It is also envisaged that the light could be powered by batteries, mains power or other power cells or by rotating the light by hand. It is also envisaged that various light emitting devices could be employed. Mention within the specification of LEDs or Luminescent wire does not imply limitation to these particular light sources

1-17. (canceled)

18. A light comprising at least one electrically powered light source and at least one rotatable blade assembly twisted around a central elongate shaft so as to form at least one partial or full helix shaped section such that upon rotation of the blade assembly the light source is rotated, the blade assembly comprising a plurality of individual blades mounted adjacent each other in a vertical plane, the blades having a surface that is shaped such that, upon its rotation about the elongate shaft, a frustroconical path is traced out by edges of the blade.

19. The light source according to claim 18, wherein a generator is coupled to the blade assembly such that upon rotation of the blade assembly electricity is generated which powers the light source.

20. The light as claimed in claim 18, wherein the light source is mounted on the blade assembly.

21. The light as claimed in claims 18 to 20, wherein the generator is wind powered.

22. The light as claimed in claims 18 to 21, wherein electricity is generated by the creation of an electromagnetic field arising upon movement of magnets.

23. The light as claimed in claims 18 to 22, wherein the generator comprises a plurality of copper coils, an array of magnets and a stator rod, said coils positioned adjacent one another so as to form a cylindrical array of cooper coils, said cylindrical copper coil array being coupled to said shaft such that upon shaft rotation the cylindrical array of copper coils rotates.

24. The light as claimed in claims 18 to 23, wherein the shaft is hollow.

25. The light as claimed in any preceding claim, wherein the blade assembly is rotatable about a vertical axis and is attached at its top end to a stationary cap.

26. The light as claimed in claim 25, wherein the blade assembly and associated shaft is attached to a base unit.

27. The light as claimed in any preceding claim, wherein the light source comprises a plurality of light emitting diodes provided on the blade assembly.

28. The light as claimed in claims 24, wherein the stator rod is attached to the cap and is positioned within the hollow shaft such that the stator rod lies substantially in the plane of rotational axis of the blade assembly.

29. The light as claimed in any preceding claim, wherein each individual rotor blade comprises a semi-frustroconical shape.

30. The light as claimed in claim 29, wherein the rotor blade includes a substantially flat top portion to the semi-frustroconical shaped rotor blades, the substantially flat top portion acting as an internal rib within the double helix shape blade assembly to discourage vertical airflow in use.

31. The light as claimed in any preceding claim, wherein the blade edges define a double helix shape.
